(19) United States
(12) Patent Application Publication
(10) Pub. No.: US 2025/0092248 A1
(43) Pub. Date: Mar. 20, 2025

(54) COMPOSITE RESIN COMPOSITIONS WITH IMIDE FUNCTIONAL ORGANOPOLYSILOXANE

(71) Applicant: MOMENTIVE PERFORMANCE MATERIALS INC., Niskayuna, NY (US)

(72) Inventors: Banpreet Kaur, Bangalore (IN); Yoichiro Ijima, Kanagawa (JP); Karthikeyan Sivasubramanian, Bangalore (IN); Kyohei Mochizuki, Kanagawa (KR); Motoshi Sasaki, Gunma (JP); Monjit Phukan, West Harrison, NY (US)

(21) Appl. No.: 18/889,785

(22) Filed: Sep. 19, 2024

(30) Foreign Application Priority Data
Sep. 19, 2023 (IN) 202311062908

(51) Int. Cl. C08L 63/00; C08K 3/36

(52) U.S. Cl. CPC C08L 63/00; C08K 3/36; C08L 2203/206

(57) ABSTRACT

A composite material is shown and described herein. The composite material comprises a reaction product of a resin and an imide-functionalized organopolysiloxane. The imide-functionalized organopolysiloxane is a siloxane modified with imide and epoxy functional groups. The composite materials may exhibit numerous useful properties including one or more of good spiral flow, coefficient of thermal expansion, moisture absorption, and/or others.

### CROSS REFERENCE TO RELATED APPLICATIONS

The present application claims priority to and the benefit of India Provisional Application 202311062908 filed on Sep. 19, 2023, the disclosure of which is incorporated herein by reference in its entirety.

### FIELD OF INVENTION

The present invention relates to a composite composition comprising a resin and a imide functional organopolysiloxane. In particular, the present invention relates to an application of a resin composition modified with an imide functional organopolysiloxane modified with imide and/or epoxy functional groups.

### BACKGROUND

Resin compositions are employed in a variety of industries and applications. Resin compositions find use, for example, in electronic packaging materials. As a method for encapsulating a semiconductor element, such as an IC and an LSI, transfer molding of a resin composition costs little, is appropriate for mass production, and thus has long been employed. The characteristics also have been improved through improvement of an epoxy resin or a phenol resin which is a curing agent in terms of reliability. However, since further integration of semiconductors has progressed year by year in accordance with the recent market trend of electronic devices being smaller and lighter and having better performances, and surface mounting of semiconductor apparatuses has been promoted, there has been an increasing demand for a resin composition for encapsulating a semiconductor having narrow path filling properties.

Epoxy resin compositions are widely used for electronic packaging materials in the electronics industry, and, in particular, as encapsulants for semiconductor elements and electronic circuits. Compositions used as electronic packaging materials must have high reliability including excellent thermal cycle resistance due to extensive temperature changes encountered through typical use of electronic devices. Accordingly, epoxy resin based compositions, and, in particular, cresol novolac-type epoxy compositions, have been widely used in the formation of molding compositions for use as electronic packaging materials.

Assembly of electronic components typically involves exposure of the electronic component to high temperatures to achieve solder reflow for establishing electrical interconnection between a chip and a substrate, as well as to achieve proper curing of any polymeric material which may be used as an underfill material between the chip and the substrate or as, an adhesive for adhering the chip to the substrate. During such processing, any moisture present within an encapsulant molding composition can result in steam build-up from such high-temperature exposure. It is believed that excessive amounts of steam build-up during such processing may result in delamination of the encapsulant electronic packaging material. As such, it is important to provide the epoxy molding compositions with a low moisture uptake, to prevent absorption of moisture by the molding composition and, thereby prevent steam build-up and delamination during processing.

### SUMMARY

The following presents a summary of this disclosure to provide a basic understanding of some aspects. This summary is intended to neither identify key or critical elements nor define any limitations of embodiments or claims. Furthermore, this summary may provide a simplified overview of some aspects that may be described in greater detail in other portions of this disclosure.

Provided is a composite composition comprising a resin and an imide functional organopolysiloxane. The imide functional organopolysiloxane comprises imide functional groups and epoxy functional groups. In embodiments, the imide and/or epoxy functional groups can be pendant to a siloxane chain. In other embodiments, the imide functional organopolysiloxane can include an imide group bridging siloxane units.

In one aspect, provided is a composition comprising: an imide-functionalized organopolysiloxane comprising an imide functional group, and at least one functional group selected from an epoxy, a hydride, an aromatic, an aliphatic, an amine, and/or an acryl or acryloxy, where the organopolysiloxane is selected from a linear siloxane and a non-linear siloxane, wherein the non-linear siloxane comprises at least two of said functional groups selected from an epoxy, a hydride, an aromatic, an aliphatic, an amine, and/or an acryl or acryloxy; a polymer resin that is reactive with the imide-functionalized organopolysiloxane;
a catalyst;
a filler; and
optionally an adhesion promoter, a release agent, and a plasticizer,
wherein the composition provides a coefficient of thermal expansion (CTE) value less than 12 ppm.

In one embodiment, the imide-functionalized organopolysiloxane is according to formula (I)

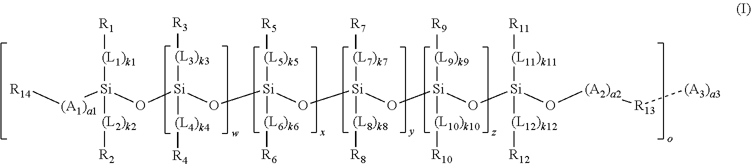

where R₁, R₂, R₃, R₄, R₅, R₆, R₇, R₈, R₉, R₁₀, R₁₁, R₁₂, R₁₃, and R₁₄ are each independently selected from hydrogen, a C1-C15 alkyl, an epoxy group, a C6-C30 aromatic containing group, and a imide group, with the provisos that (i) at least one of R₁, R₂, R₃, R₄, R₅, R₆, R₇, R₈, R₉, R₁₀, R₁₁, R₁₂, R₁₃, and R₁₄ is selected from an imide group, and (ii) at least one of R₁, R₂, R₃, R₄, R₅, R₆, R₇, R₈, R₉, R₁₀, R₁₁, R₁₂, R₁₃, and R₁₄ is selected from an epoxy group;
A₁, A₂, A₃, and L₁, L₂, L₃, L₄, L₅, L₆, L₇, L₈, L₉, L₁₀, L₁₁, and L₁₂ are linker groups each independently selected from a divalent alkyl group, a divalent alkenyl group, and a divalent ether groups;
o is ≥1;
w, x, y, and z are each ≥0, where (w+x+y+z) is from 1 to 60;
k1, k2, k3, k4, k5, k6, k7, k8, k9, k10

In one embodiment, at least one of R₁, R₂, R₃, R₄, R₅, R₆, R₇, R₈, R₉, R₁₀, R₁₁, and/or R₁₂ is selected from an imide, at least one of R₁, R₂, R₃, R₄, R₅, R₆, R₇, R₈, R₉, R₁₀, R₁₁, and/or R₁₂ is selected from an epoxy, and least one of R₁, R₂, R₃, R₄, R₅, R₆, R₇, R₈, R₉, R₁₀, R₁₁, and/or R₁₂ is selected from an C6-C30 aromatic group.

In one embodiment, R₁, R₂, R₃, R₄, R₅, R₇, R₉, R₁₀, R₁₁, and R₁₂ are independently selected from hydrogen, a C1-C15 alkyl group, and a C6-C30 aromatic, R₁₃ is selected from an imide functional group, and R₁₄ is selected from an epoxy functional group.

In one embodiment, R₁, R₂, R₃, R₄, R₅, R₆, R₇, R₈, R₉, R₁₀, R₁₁, and/or R₁₂ are each independently selected from hydrogen and a C1-C15 alkyl group, and R₁₃ and R₁₄ are selected from a substituted or non-substituted bisimide.

In one embodiment in accordance with any of the previous embodiments, the imide group is selected from a group of the formulas (IV), (V), and (VI):

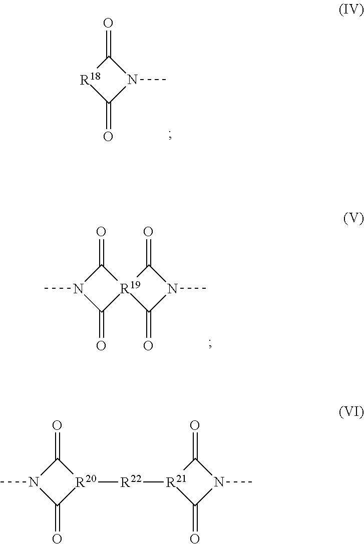

where R¹⁸, R¹⁹, R²⁰, and R²1 are independently selected from a C2 to C30 divalent hydrocarbon, and R²² is selected from a bond or C1-C10 divalent hydrocarbon.

In one embodiment in accordance with any of the previous embodiments, the imide-functionalized organopolysiloxane siloxane is of the formula:

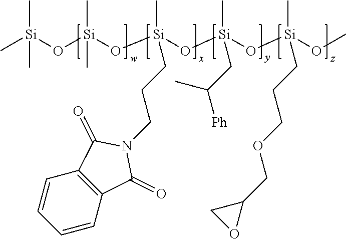

In one embodiment in accordance with any of the previous embodiments, the imide-functionalized organopolysiloxane siloxane is of the formula:

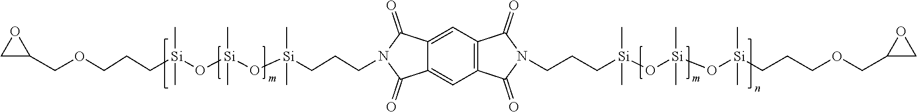

In one embodiment in accordance with any of the previous embodiments, the imide-functionalized organopolysiloxane is present in an amount of from about 1 wt. % to about 10 wt. %. In one embodiment in accordance with any of the previous embodiments, the imide-functionalized organopolysiloxane is present in an amount of from about 1 wt. % to about 5 wt. %. In one embodiment in accordance with any of the previous embodiments, the imide-functionalized organopolysiloxane is present in an amount of from about 1 wt. % to about 2 wt. %.

In one embodiment in accordance with any of the previous embodiments, the polymer resin is a combination of a functional resin and at least one resin hardener.

In one embodiment in accordance with any of the previous embodiments, the functional resin is selected from an epoxy resin, a polyurethane resin, a polyamide resin, a polyimide resin, an acrylic resin, a siloxane resin, a phenol resin, or a combination of two or more thereof.

In one embodiment in accordance with any of the previous embodiments, the functional resin is present in an amount of from about 7 wt. % to about 35 wt. %. In one embodiment in accordance with any of the previous embodiments, the functional resin is present in an amount of from about 7 wt. % to about 20 wt. %. In one embodiment in accordance with any of the previous embodiments, the functional resin is present in an amount of from about 10 wt. % to about 7 wt. %.

In one embodiment in accordance with any of the previous embodiments, the resin hardener is selected from a phenol resin, a phenol-derived resin, a substituted phenol-derived resin, or an anhydrite resin.

In one embodiment in accordance with any of the previous embodiments, the resin hardener is present in an amount of from about 5 wt. % to about 30 wt. %. In one embodiment in accordance with any of the previous embodiments, the resin hardener is present in an amount of from about 5 wt. % to about 20 wt. %. In one embodiment in accordance with any of the previous embodiments, the resin hardener is present in an amount of from about 5 wt. % to about 10 wt. %.

In one embodiment in accordance with any of the previous embodiments, the composition comprises the resin hardener and the functional resin in a ratio of between 1:1 to 1:1.5.

In one embodiment in accordance with any of the previous embodiments, the composition is a 2-part epoxy curing system.

In one embodiment in accordance with any of the previous embodiments, the filler comprises alumina, fused silica, or combinations thereof.

In one embodiment in accordance with any of the previous embodiments, the composition has a CTE value lower than 11 ppm. In one embodiment in accordance with any of the previous embodiments, the composition has a CTE value lower than 10 ppm. In one embodiment in accordance with any of the previous embodiments, the composition has a CTE value lower than 9 ppm. In one embodiment in accordance with any of the previous embodiments, the composition has a CTE value lower than 8 ppm.

In one embodiment in accordance with any of the previous embodiments, the composition has a spiral flow of from about 50 cm to about 100 cm.

In another aspect, provided is an epoxy molding compound formed from the composition in accordance with any of the previous embodiments.

In still another aspect, provided is an article comprising a material formed from the composition in accordance with any of the previous embodiments.

In one embodiment, the article selected from a semiconductor packaging, an electronic material, or an electronic coating.

In one embodiment, the article is an electronic component comprising the material.

The following description and the drawings disclose various illustrative aspects. Some improvements and novel aspects may be expressly identified, while others may be apparent from the description and drawings.

### DETAILED DESCRIPTION

Reference will now be made to exemplary embodiments, examples of which are illustrated in the accompanying drawings. It is to be understood that other embodiments may be utilized and structural and functional changes may be made. Moreover, features of the various embodiments may be combined or altered. As such, the following description is presented by way of illustration only and should not limit in any way the various alternatives and modifications that may be made to the illustrated embodiments. In this disclosure, numerous specific details provide a thorough understanding of the subject disclosure. It should be understood that aspects of this disclosure may be practiced with other embodiments not necessarily including all aspects described herein, etc.

As used herein, the words “example” and “exemplary” means an instance, or illustration. The words “example” or “exemplary” do not indicate a key or preferred aspect or embodiment. The word “or” is intended to be inclusive rather than exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

Provided is a composite composition comprising a resin and an imide functional organopolysiloxane material. The imide functional organopolysiloxane comprises a siloxane modified with an imide functional group. The imide functional group can be pendant to a siloxane unit, or the imide group may be disposed in the backbone of the material (so as to effectively link two or more siloxane units. In one embodiment, the imide functional organopolysiloxane comprises an imide functional group, and at least one functional group selected from an epoxy, a hydride, an aromatic, an aliphatic, an amine, and/or an acryl or acryloxy, where the siloxane is selected from a linear siloxane and a non-linear siloxane, wherein the non-linear siloxane comprises at least two of said functional groups selected from an epoxy, a hydride, an aromatic, an aliphatic, an amine, and/or an acryl or acryloxy. The resin is reactive with the imide functional organopolysiloxane. The resin is a combination of functional resin and a resin hardener. The composite composition may include other components such as, but not limited to, a catalyst, a filler, a hardener. In presence of the imide functional organopolysiloxane material, the composite composition can achieve the desired CTE values (lowering of CTE), reduced moisture uptake, and improves spiral flow, gel time and mechanical strength.

The present technology provides a composition comprising an imide functional organopolysiloxane material comprising imide and epoxy functional groups. In one embodiment, the imide functional organopolysiloxane material is a compound having the structural formula (I):

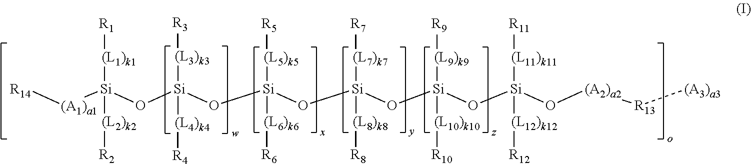

where R₁, R₂, R₃, R₄, R₅, R₆, R₇, R₈, R₉, R₁₀, R₁₁, R₁₂, R₁₃, and R₁₄ are each independently selected from hydrogen, a C1-C15 alkyl, an epoxy group, a C6-C30 aromatic containing group, and a imide group, with the provisos that (i) at least one of R₁, R₂, R₃, R₄, R₅, R₆, R₇, R₈, R₉, R₁₀, R₁₁, R₁₂, R₁₃, and R₁₄ is selected from an imide group, and (ii) at least one of R₁, R₂, R₃, R₄, R₅, R₆, R₇, R₈, R₉, R₁₀, R₁₁, R₁₂, R₁₃, and R₁₄ is selected from an epoxy group;
A₁, A₂, A₃, and L₁, L₂, L₃, L₄, L₅, L₆, L₇, L₈, L₉, L₁₀, L₁₁, and L₁₂ are linker groups each independently selected from a divalent alkyl group, a divalent alkenyl group, or a divalent ether group,
o is ≥1;
w, x, y, and z are each ≥0, where (w+x+y+z) is from 1 to 60;
k1, k2, k3, k4, k5, k6, k7, k8, k9, k10, k11, k12 are each independently ≥0; and
a1, a2, and a3 are each independently ≥0.

The C1-C15 alkyl group can be selected from linear or branched groups. In one embodiment, the C1-C15 alkyl group is selected from methyl, ethyl, propyl, isopropyl, butyl, isobutyl, tert-butyl, pentyl, isopentyl, hexyl, heptyl, octyl, and isooctyl.

The C6-C30 aromatic groups can be selected from an aryl, an arylalkyl, and an alkaryl group. The term “aryl” means any monovalent aromatic hydrocarbon group; the term “aralkyl” means any alkyl group (as defined herein) in which one or more hydrogen atoms have been substituted by the same number of like and/or different aryl (as defined herein) groups; and, the term “arylakyl” means any aryl group (as defined herein) in which one or more hydrogen atoms have been substituted by the same number of like and/or different alkyl groups (as defined herein). The aromatic group can comprise one or more aromatic rings. In a group with multiple aromatic rings, the rings can be joined by a bond, joined by a linker group (e.g., a divalent hydrocarbon group or a group with heteroatoms), or may be a fused ring system. An aromatic radical may be an array of atoms having a valence of at least one and having at least one aromatic group. This may include heteroatoms such as nitrogen, sulfur, selenium, silicon and oxygen, or may be composed exclusively of carbon and hydrogen. Suitable aromatic radicals may include phenyl, pyridyl, furanyl, thienyl, naphthyl, phenylene, and biphenyl radicals. The aromatic group may be a cyclic structure having 4n+2 “delocalized” electrons where “n” may be an integer equal to 1 or greater, as illustrated by phenyl groups (n=1), thienyl groups (n=1), furanyl groups (n=1), naphthyl groups (n=2), azulenyl groups (n=2), anthracenyl groups (n=3) and the like. The aromatic radical also may include non-aromatic components. For example, a benzyl group may be an aromatic radical, which may include a phenyl ring (the aromatic group) and a methylene group (the non-aromatic component). Similarly a tetrahydronaphthyl radical may be an aromatic radical comprising an aromatic group (C₆H₃) fused to a non-aromatic component (CH₂)₄—. An aromatic radical may include one or more functional groups, such as alkyl groups, alkenyl groups, alkynyl groups, haloalkyl groups, haloaromatic groups, conjugated dienyl groups, alcohol groups, ether groups, aldehyde groups, ketone groups, carboxylic acid groups, acyl groups (for example carboxylic acid derivatives such as esters and amides), amine groups, nitro groups, and the like. For example, the 4-methylphenyl radical may be a C₇ aromatic radical comprising a methyl group, the methyl group being a functional group, which may be an alkyl group. Similarly, the 2-nitrophenyl group may be a C₆ aromatic radical comprising a nitro group, the nitro group being a functional group. Examples of C6-C30 aromatic groups include, but are not limited to phenyl, naphthyl; o-, m- and p-tolyl, xylyl, ethylphenyl, and benzyl.

In one embodiment, at least one of R₁, R₂, R₃, R₄, R₅, R₆, R₇, R₈, R₉, R₁₀, R₁₁, and/or R₁₂ is selected from an imide, at least one of R₁, R₂, R₃, R₄, R₅, R₆, R₇, R₈, R₉, R₁₀, R₁₁, and/or R₁₂ is selected from an epoxy, and least one of R₁, R₂, R₃, R₄, R₅, R₆, R₇, R₈, R₉, R₁₀, R₁₁, and/or R₁₂ is selected from an C6-C30 aromatic group. In this embodiment, the residual groups of R₁, R₂, R₃, R₄, R₅, R₆, R₇, R₈, R₉, R₁₀, R₁₁, and/or R₁₂ are each independently selected from a C₁-C₁₅ alkyl group.

In one embodiment, R₁, R₂, R₃, R₄, R₅, R₇, R₉, R₁₀, R₁₁, and R₁₂ are independently selected from hydrogen, a C1-C15 alkyl group, and a C6-C30 aromatic, R₁₃ is selected from an imide functional group, and R₁₄ is selected from an epoxy functional group.

In one embodiment, R₁, R₂, R₃, R₄, R₅, R₆, R₇, R₈, R₉, R₁₀, R₁₁, and/or R₁₂ are each independently selected from hydrogen and a C1-C15 alkyl group, and R₁₃ and R₁₄ are selected from a substituted or non-substituted bisimide.

The epoxy group is not particularly limited and can be selected as desired for a particular purpose or intended application. In one embodiment, the epoxy group is selected from a glycidyl group or a glycidyl ether group. The epoxy group can be of the formula (II) or (III):

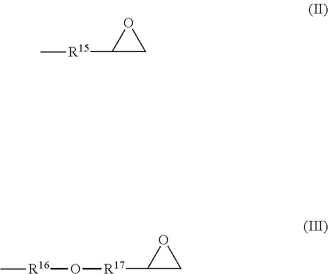

where R¹⁵, R¹⁶, and R¹⁷ are each independently selected from a C1-C10 divalent hyrdocarbon group.

The imide group can be selected from a group comprising an imide functionality. In embodiments, the imide functionality is selected from a group of the formulas (IV), (V), and (VI):

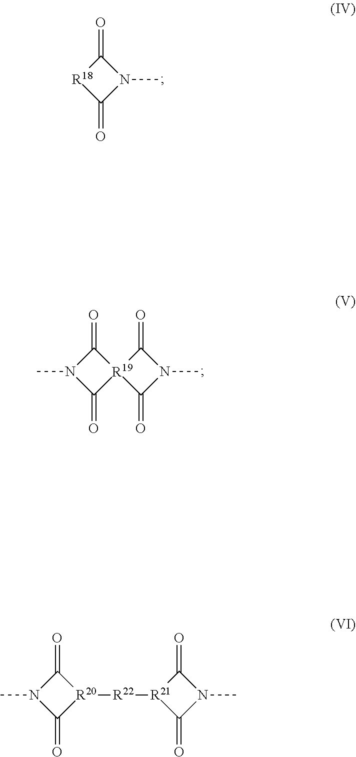

where R¹⁸, R¹⁹, R²⁰, and R²¹ are independently selected from a C2 to C30 divalent organic group, and R²² is selected from a bond, a C₁-C₃₀ divalent organic group, or an O atom. The C2 to C30 divalent group can be saturated, unsaturated, linear, branched, cyclic, an aromatic group or the like, and may be unsubstituted or substituted.

In one embodiment, R¹⁸, R²⁰, and R²¹ are each independently selected from a C₂ to C₃₀ divalent chain so as to form a single ring. In one embodiment, R¹⁸, R²⁰, and R²¹ are independently selected from a C2 to C6 divalent chain. In one embodiment, R¹⁸, R²⁰, and R²¹ are independently selected from a C2 or C3 divalent group to provide a five or six membered imide ring.

In one embodiment, R¹⁹ is a C5-C30 cyclic containing hydrocarbon. In one embodiment, the cyclic containing hydrocarbon can be an unsaturated ring, a saturated ring, a fused ring system that may be saturated or unsaturated, or a multiple ring system that is separated by a bond or other linker group. The rings may be, in embodiments, aromatic rings.

In one embodiment, R¹⁸, R²⁰, and R²¹ are each independently selected from a C₅-C₃₀ cyclic containing hydrocarbon. In one embodiment, the cyclic containing hydrocarbon can be an unsaturated ring, a saturated ring, a fused ring system that may be saturated or unsaturated, or a multiple ring system that is separated by a bond or other linker group. The rings may be, in embodiments, aromatic rings.

Some non-limiting examples of R¹⁸ include:

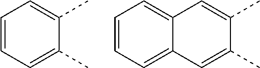

Non-limiting examples of R¹⁹ include:

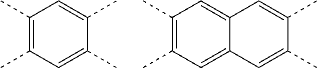

Non-limiting examples of R²⁰ and R²¹ include:

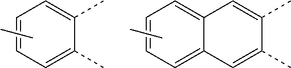

R²² is selected from a bond, a C1 to C30 divalent organic group, or an O atom. The divalent organic group can be linear, branched, or contain one or more cyclic groups including, for example, C₆ to C30 aromatic groups. The C1 to C30 divalent organic group can be unsubstituted or substituted. Substituted organic groups may include, for example, one or more heteroatoms selected from N, O, S, and/or a halo group (e.g., F). In one embodiment, R²² is selected from a divalent C1-C10 group. In one embodiment, R²² is selected from —CH₂—, —CH₂CH₂—, or —CH₂CH₂CH₂—. In one embodiment, R²² is selected from a —O— linkage. In one embodiment, R²² is selected from a C1-C10 group optionally containing at least one C—O—C linkage. In one embodiment, R²² is selected from a divalent C1-C10 group wherein one or more hydrogens are replaced with a fluorine atom. In one embodiment, R²² is selected from a —(CF₂)n- where n is 1 to 10. In one embodiment, R²² is selected from a (—C(CF₃)(CF₃)-)m, where m is 1 to 10.

Some examples of suitable imide groups include, but are not limited to:

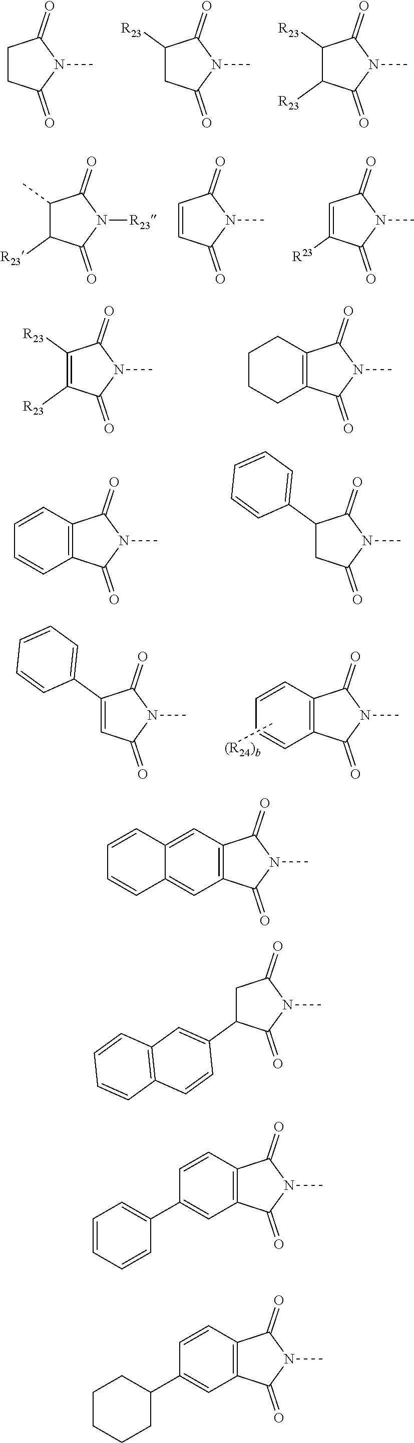

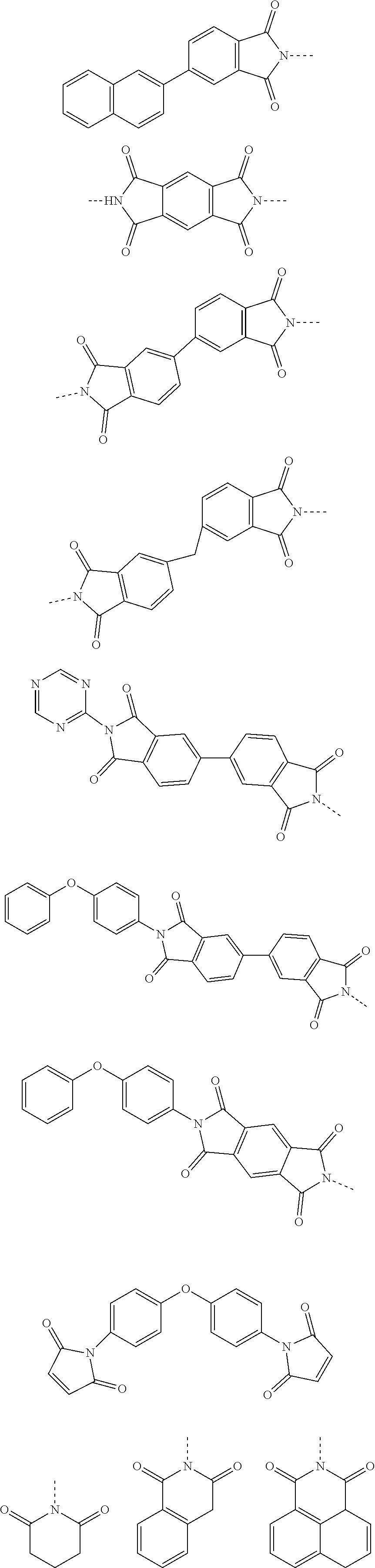

where R²³ and R²⁴ may be selected from hydrogen, a C1-C15 alkyl, an epoxy group, a C₄ to C₂₀ cyclic group, a C6-C30 aromatic containing group, which may be substituted or unsubstituted, and where the carbon atoms in the cyclic or aromatic group can be replaced by a heteroatom selected from O, N, or S. b is an integer of 0 to 4. R^{23′} is a divalent organic group containing glycidoxy and imide substitutions, and R²³″ is an amino terminal siloxane.

In one embodiment, R¹ through R¹² are independently selected from hydrogen, an epoxy group, a C1-C15 alkyl, a C6-C30 aromatic group, and an imide group, and R¹³ and R¹⁴ are selected from a C1-C15 alkyl, where at least one of R¹ through R¹² is selected from an imide, and at least one of R¹ through R¹² is selected from an epoxy. In one embodiment, R¹, R², R³, R⁴, R⁵, R⁷, R⁹, R¹⁰, R¹¹, and R¹² are independently selected from hydrogen, a C1-C15 alkyl, and a C₆-C₃₀ aromatic, R⁶ is selected from an imide functional group, and R⁸ is selected from an epoxy functional group. In an exemplary embodiment, the imide functional organopolysiloxane comprises an imide functional group, an epoxy functional group, an alkenyl aryl group in the pendant position, as shown in Structure A:

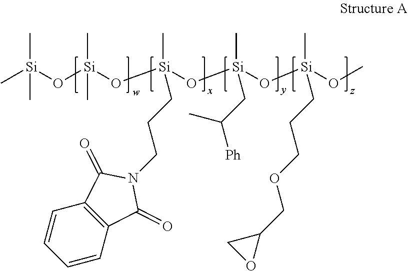

In one embodiment, R₁ through R₁₂ are independently selected from hydrogen or a C1-C15 alkyl, and R₁₃ and R₁₄ are independently selected from an imide containing group. In an exemplary embodiment, the imide functional organopolysiloxane is a linear molecule comprising an imide functional group connected to siloxane backbone with terminal epoxy functional groups, as shown in, Structure B:

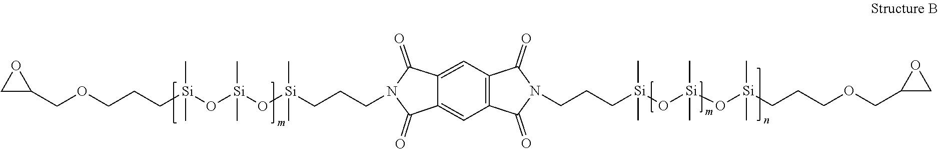

In an exemplary embodiment, the imide functional organopolysiloxane comprises triazene substituted bisimide functional groups as shown in Structure C:

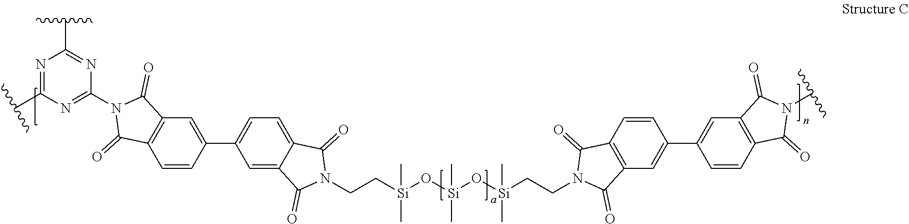

In another exemplary embodiment, the imide functional organopolysiloxane comprises diphenyl ether substituted bisimide functional groups wherein the R₁₉ is a benzene ring as shown in, Structure D:

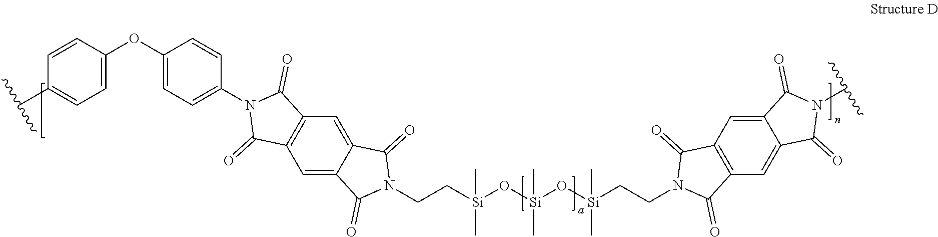

In another exemplary embodiment, the imide functional organopolysiloxane comprises diphenyl ether substituted bisimide functional groups wherein the R₁₉ is multiple ring system, such as biphenyl as shown in, Structure E:

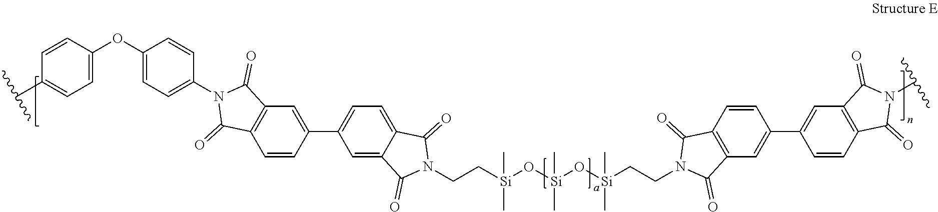

In another exemplary embodiment, the imide functional organopolysiloxane comprises multiple imide and substituted bisimide functional groups, wherein the R₁₄ is bisimide substituted organopolysiloxane (Structure (I)) and R₁₃ is imide substituted organopolysiloxane (Structure (I)), and R₁₄ and R₁₃ are connected through ethylene linkers (A1 and A2) to the siloxane backbone as shown in, Structure F:

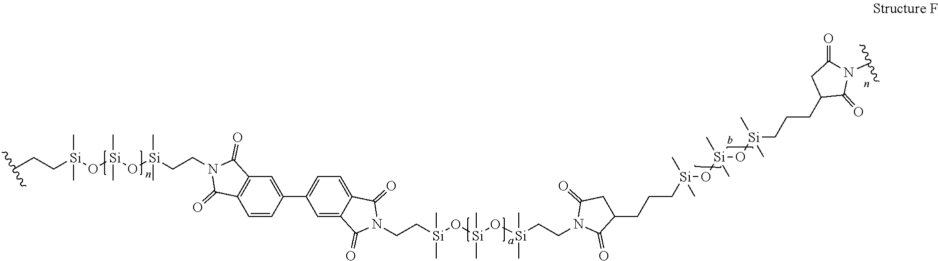

In another exemplary embodiment, the imide functional organopolysiloxane comprises siloxane backbone with two linkers at two ends, including a linker (A1) of substituted divalent alkyl, such as amino alkyl at one end and a linker (A2) of amino alkyl at another end with a substitution of —CH(OH)—CH2-O—CH2-, and wherein the R₁₃ is substituted imide, wherein the substituted imide containing R_{23′} which is a divalent organic group containing glycidoxy and imide substitutions, and the substituted imide also contains R^{23″} which is an amino terminal siloxane as shown in Structure G:

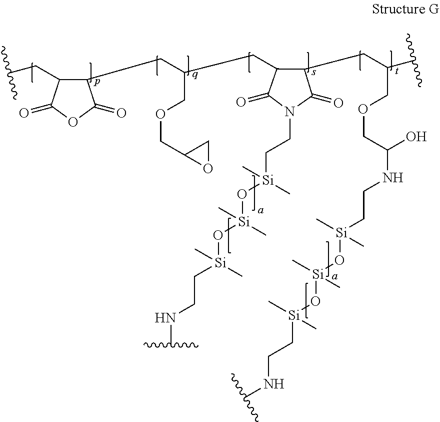

In another exemplary embodiment, the imide functional organopolysiloxane comprises multiple imide and substituted bisimide functional groups, wherein the R₁₄ is bisimide substituted organopolysiloxane (Structure (I)) and R₁₃ is imide substituted organopolysiloxane (Structure (I)), and R₁₄ and R₁₃ are connected through ethylene linkers (A₁ and A₂) to the siloxane backbone as shown in Structure H:

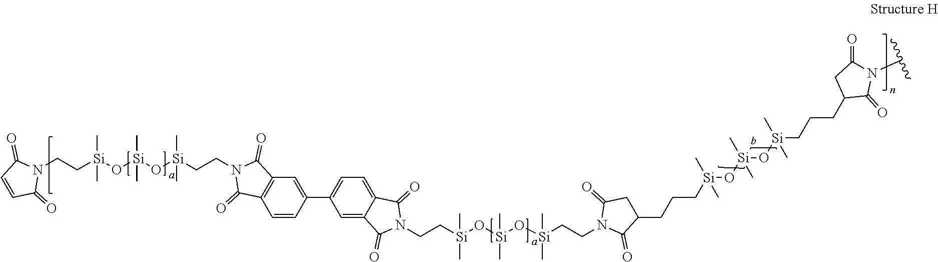

In another exemplary embodiment, the imide functional organopolysiloxane comprises multiple imide and substituted bisimide functional groups, wherein the R₁₄ is bisimide substituted organopolysiloxane (Structure (I)) and R₁₃ is imide substituted organopolysiloxane (Structure (I)), and R₁₄ and R₁₃ are connected through ethylene linkers (A₁ and A₂) to the siloxane backbone, and R²² is —C(CF₃)₂ as shown in, Structure J:

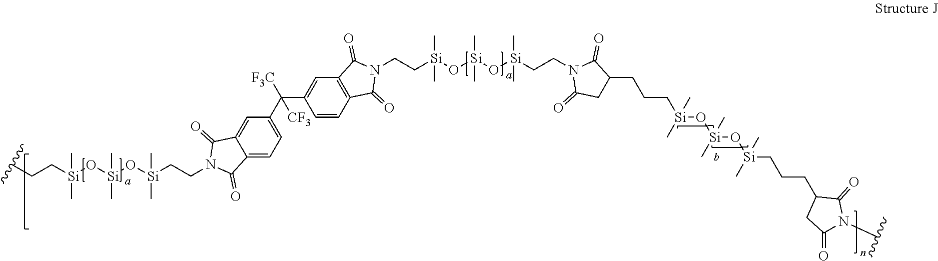

In another exemplary embodiment, the imide functional organopolysiloxane comprises multiple imide and triazine substituted bisimide functional groups, wherein the R₁₄ is triazine substituted bisimide (Structure (I)) and R13 is imide substituted organopolysiloxane (Structure (I)), and R₁₄ and R₁₃ are connected through ethylene linkers (A₁ and A₂) to the siloxane backbone, and R²² is —C(CF₃)₂ as shown in, Structure K:

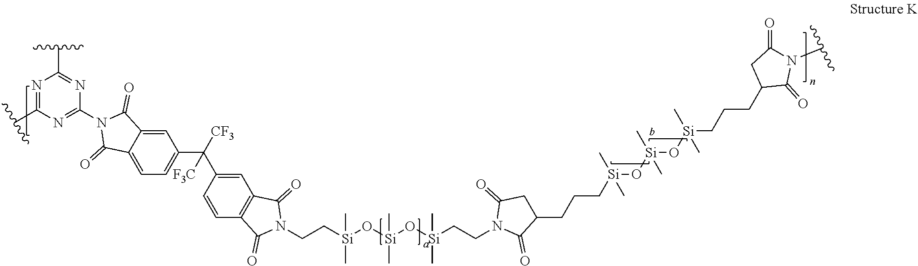

Structures A-K illustrate examples of embodiments of imide functional organopolysiloxanes in accordance with aspects of the present technology as described above.

In one embodiment, compounds in accordance with the present technology can be prepared by introducing the imide groups and the epoxy groups to a siloxane unit via hydrosilylation reaction. In one embodiment, an alkenyl functional imide is reacted with a hydride functional siloxane to provide an imide functional siloxane. The reaction can be controlled such that there is a molar excess of hydride functional groups after reaction with the imide such that imide functional siloxane comprises hydride functional moieties. The imide functional siloxane comprising hydride functional groups is then reacted with an alkenyl functional epoxy to yield the imide functional organopolysiloxane.

The reaction can be conducted in a solvent. Solvent may be needed, for example, to dissolve the alkenyl functional imides. The reaction can also be conducted at elevated temperatures. In embodiments, the reaction for both the addition of the imide and the addition of the epoxy group can be conducted at temperatures of from about 50° C. to about 110° C., from about 60° C. to about 100° C., or from about 75° C. to about 90° C.

The alkenyl functional imide can be, for example selected from a compound of the formula:

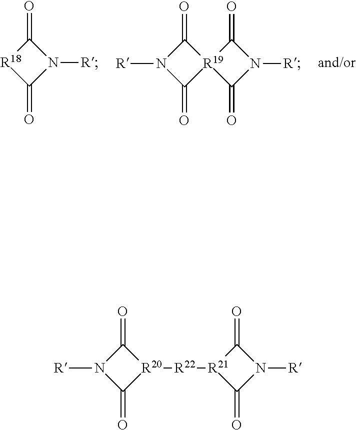

where R¹⁸, R¹⁹, R²⁰, R²¹, and R²² are as described above, and R′ is independently selected from a C2-C30 alkenyl functional group. Generally, the alkenyl functional group comprises a terminal alkenyl group. In embodiments, R′ is selected from a vinyl, allyl, methallyl, butenyl, isobutenyl, sec-butenyl, pentenyl, hexenyl, heptenyl, ocetenyl, nonenyl, or decenyl functional group as well as branched groups of 6 or more carbon atoms.

A hydrosilylation catalyst is employed for each of the reactions. The catalyst employed in the reaction of the alkenyl functional imide may also be employed in the reaction of the alkenyl functional epoxy with the imide functionalized siloxane. The hydrosilylation catalyst is not particularly limited, and any suitable hydrosilylation catalyst can be employed in the reaction. In one embodiment, the catalyst is selected from a hydrosilylation catalyst based on a platinum-group metal. For the purposes of the present invention, the expression “platinum-group metals” means the metals ruthenium, rhodium, palladium, osmium, iridium, and platinum. In one embodiment, the hydrosilylation catalyst is based on platinum. Hydrosilylation catalysts that are further preferred are platinum-alkenylsiloxane complexes. Preference is in particular given to a hydrosilylation catalyst selected from the group consisting of platinum-1,3-divinyl-1,1,3,3-tetramethyldisiloxane complex (Karstedt complex), platinum-1,3-diallyl-1,1,3,3-tetramethyl-disiloxane complex, platinum-1,3-divinyl-1,3-dimethyl-1,3-diphenyldisiloxane complex, platinum-1,1,3,3-tetraphenyldisiloxane complex and platinum-1,3,5,7-tetramethyl-1,3,5,7-tetravinylcyclotetrasiloxane complex. More preferably, the hydrosilylation catalyst is platinum-1,3-divinyl-1,1,3,3-tetramethyldisiloxane complex (Karstedt complex).

In an alternative embodiment, an alkenyl functional siloxane can be employed with a hydride functional imide to provide an imide functional siloxane. The reaction can be controlled such that there is a molar excess of alkenyl functional groups after reaction with the imide such that imide functional siloxane comprises alkenyl functional moieties. The imide functional siloxane comprising alkenyl functional moieties is then reacted with a hydride functional epoxy to yield the imide functional organopolysiloxane.

In another embodiment, imide functionalized organopolysiloxanes in accordance with the present technology can be prepared by an imidization reaction. The imidization reaction comprises adding an aliphatic or aromatic substituted dianhydride; a diamino or dianhydride functional siloxane; and an aliphatic or aromatic functional amine to produce an imide functional siloxane comprising one or more substituents. The imidization reaction comprises reacting a diamino siloxane with a dianhydride and optionally a functional amino organic group and/or an anhydride and heating the mixture. The reaction can be conducted as a “one pot” reaction. In embodiments, the reaction can be conducted at a temperature of from about 100° C. to about 200° C., of from about 120° C. to about 180° C., from about 130° C. to about 170° C., or from about 150° C. to about 160° C.

The diamino siloxane is a siloxane of a desired chain length having terminal amino groups.

The dianhydride can be selected to provide an imide of a desired structure. In embodiments, the dianhydride is selected from a compound of the formulas:

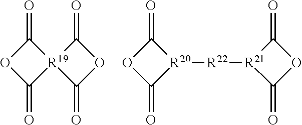

where R₁₉, R₂₀, R₂₁, and R²² are as described above.

The functional amine may comprise the organic group including, but is not limited to, aliphatic, cyclic, acyclic, alicyclic, heterocyclic, aromatic, and heteroaromatic. In some embodiments, the functional amine includes, but is not limited to, mono amines, di-amines, tri-amines. In such embodiments, each of these amines may be a primary amine, a secondary amines or a tertiary amine.

The imidization reaction can optionally employ an anhydride terminated siloxane where the anhydride terminated siloxane is obtained by hydrosilylation reaction of an alkenyl functional anhydride with hydride functional siloxane. The alkenyl functional anhydride can be of the formula:

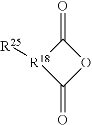

where R¹⁸ is as described above, and R²⁵ is an alkenyl functional group. The alkenyl functional group can be selected from a C2-C30 alkenyl functional group. Examples of R²⁵ include, but are not limited to, vinyl, allyl, methallyl, butenyl, isobutenyl, sec-butenyl, pentenyl, hexenyl, heptenyl, ocetenyl, nonenyl, or decenyl functional group as well as branched groups of 6 or more carbon atoms.

The imide functional organopolysiloxane can be present in the composition in an amount of from about 1 wt. % to about 10 wt. %, from about 1 wt. % to about 5 wt. % or from about 1 wt. % to about 2 wt. %.

### Functional Resin

The functional resin may be selected as desired for a particular purpose or intended application. The functional resin is not particularly limited except to the extent that the resin should be reactive with imide functional organopolysiloxane.

Examples of suitable functional resins include, but are not limited to, epoxy resins, polyurethane resins, polyamide resins, polyimide resins, acrylic resins, siloxane resins, phenol resins, and the like.

In one embodiment, the functional resin is an epoxy resin. The epoxy resin component may be any type of epoxy resin useful in molding compositions, including any material containing two or more reactive oxirane groups. The epoxy resin may have two or more epoxy groups in one molecule, including glycidyl ether type; glycidyl-ester type; alicyclic type; heterocyclic type and halogenated epoxy resins, etc. Non-limiting examples of suitable epoxy resins include epoxy cresol novolac resin, phenolic novolac epoxy resin, biphenyl epoxy resin, hydroquinone epoxy resin, stilbene epoxy resin, and mixtures and combinations thereof. Epoxy cresol novolac resin is particularly desirable for use in the present invention. The epoxy resins may be used either individually or as a mixture of two or more resins, such as a combination of epoxy cresol novolac and biphenyl epoxy resin.

Specific examples of another epoxy resins that can be preferably used in combination include biphenol or biphenol crystalline epoxy resins or mixtures thereof such as YX-4000 available from Japan Epoxy Resins and CER-3000 available from NIPPON KAYAKU CO., LTD. (trade names); bisphenol S crystalline epoxy resins; bisphenol fluorene crystalline epoxy resins; hydroquinone crystalline epoxy resins; heterocyclic crystalline epoxy resins such as TEPIC (trade name) available from NISSAN CHEMICAL INDUSTRIES, LTD., crystalline epoxy resins of glyoxal-phenol condensate, trisphenolmethane crystalline epoxy resins and biphenyl novolak crystalline epoxy resins (e.g., crystalline epoxy resins having a skeleton similar to that of NC-3000 available from NIPPON KAYAKU CO., LTD.). These may be used alone or in combination of two or more. The resin can be an epoxy resin (or mixture of resins) to form an epoxy molding composition.

The resin can be present in the composition in an amount of from about 7 wt. % to about 35 wt. %, from about 7 wt. % to about 20 wt. % or from about 10 wt. % to about 7 wt. %.

### Resin Hardener

The composite composition includes a resin hardener to promote crosslinking of the resin. The resin hardener can be selected as desired for a particular purpose or intended application based on the resins employed in the composition. In one embodiment the hardener is selected from a phenol-derived or substituted phenol-derived novolac or an anhydride. Non-limiting examples of suitable hardeners include phenol novolac hardener, cresol novolac hardener, dicyclopentadiene phenol hardener, limonene type hardener, anhydrides, and mixtures thereof.

Suitable anhydride hardeners as curing agents include, but are not limited to, maleic anhydride; methyltetrahydrophtalic anhydride; methyl-4-endomethylene tetrahydrophtalic anhydride; hexahydrophtalic anhydride; tetrahydrophtalic anhydride; dodecenyl succinic anhydride. An exemplary anhydride hardener is methyltetrahydrophtalic anhydride (MTHPA).

The resin hardener can be present in the composition in an amount of from about 5 wt. % to about 30 wt. %, from about 5 wt. % to about 20 wt. % or from about 5 wt. % to about 10 wt. %.

In one embodiment, the resin hardener and the functional resin are present in the composition such that the ratio of resin hardener to functional resin is between 1:1 to 1:1.5; 1:1.1 to 1:1.4, or 1:1.2 to 1:1.3.

### Catalyst

The composition includes a catalyst. The term “catalyst” and “cure accelerator” may be used interchangeably, and generally refer to a material that catalyzes or accelerates the curing reaction between the resin and the siloxane additive. The catalyst may be selected in part based on the resin. Examples of suitable catalysts include, but are not limited to, basic and acidic catalysts such as metal halide Lewis acids, including boron trifluoride, stannic chloride, zinc chloride and the like; metal carboxylate-salts such as stannous octoate and the like; and amines, such as triethylamine, imadazole derivatives, and the like.

Examples of suitable cure accelerators include, but are not limited to, polyamines such as diaminodiphenyl methane, m-phenylene diamine, diaminodiphenyl sulfone, cyclohexyl amine, m-xylylene diamine, 4,4′-diamino-3,3′-diethyldiphenyl methane, diethylene triamine, tetraethylene pentamine, N-aminoethyl piperazine, isophorone diamine, dicyandiamide, urea, urea derivatives, melamine, polybasic hydrazide, and organic acid salts thereof and/or epoxy adducts; amine complexes of boron trifluoride; tertiary amines such as trimethyl amine, triethanol amine, N,N-dimethyloctyl amine, N,N-dimethyl aniline, N-benzyldimethyl amine, pyridine, N-methylpyridine, N-methyl morpholine, hexamethoxymethyl melamine, 2,4,6-tris(dimethylaminophenol), N-cyclohexyldimethyl amine, tetramethyl guanidine, and m-aminophenol; polyphenols such as polyvinyl phenol, polyvinyl phenol bromide, phenol novolak, and alkylphenol novolaks; organic phospines such as tributyl phosphine, triphenyl phosphine, and tris-2-cyanoethyl phosphine; phosphonium salts such as tri-n-butyl(2,5-dihydroxyphenyl)phosphonium bromide and hexadecyltributyl phosphonium chloride; quaternary ammonium salts such as benzyltrimethyl ammonium chloride, phenyltributyl ammonium chloride, and benzyltrimethyl ammonium bromide; anhydrides of the polybasic acids metnioned above; photo-cationic polymerization catalysts such as diphenyl iodonium tetrafluoroborate, triphenyl sulfonium hexafluoroantimonate, 2,4,6-triphenyl thiopyrilium hexafluorophosphate, the product of Ciba-Geigy Ltd. under registered trademark designation of “IRGACURE” 261, and styrenemaleic acid resin.

The catalyst can be present in the composition in an amount of from about 0.1 wt. % to about 0.5 wt. %, from about 0.1 wt. % to about 0.3 wt. % or from about 0.1 wt. % to about 0.2 wt. %.

### Plasticizer

The composite composition may include a plasticizer. Examples of suitable plasticizers include, but are not limited to, sulfonate plasticizers, phosphate ester plasticizers, sulfonamide plasticizers, glycerin triester plasticizers, dialkyl esters of aliphatic dicarboxylic acids, glycol esters of benzoic acid, diols, and the like. In one embodiment, the plasticizer may be a diol, including a diol which is solid at room-temperature. The plasticizer substantially functions as a flexibilizer.

Examples of diols include, but are not limited to, aromatic diols such as bisphenol A, bisphenol F, aliphatic monomeric or polymeric diols such as polyethylene glycols (PEG) or polypropylene glycols (PPG), or neopentyl glycol. An exemplary embodiment provides that bisphenol A, bisphenol F and neopentyl glycol or a mixture of these compounds can be utilized as the diols. For example, neopentyl glycol and bisphenol A or a mixture of these compounds can be utilized.

Examples of sulfonate plasticizers include, but are not limited to, alkyl sulfonic acid esters of phenolic compounds such as the phenyl cresyl esters of pentadecyl sulfonic acid. Suitable commercially available sulfonate plasticizers include the plasticizer sold by Bayer under the tradename MESAMOLL.

Examples of phoshpate ester plasticizers include, but are not limited to, the organic esters of phosphoric acid, such as, for example, phenolic esters of phosphoric acid, e.g., tricresyl phosphate, cresyl diphenyl phosphate, isopropylated triphenyl phosphate, 2-ethylhexyl diphenyl phosphate, isodecyl diphenyl phosphate, and triphenyl phosphate, as well as other triaryl phosphates and alkyl diaryl phosphates. Other suitable phosphate plasticizers include, but are not limited to, tributoxyethyl phosphate, tributyl phosphate, and the like.

Suitable glycerin triester plasticizers include, but are not limited to, the compounds described in U.S. Pat. No. 6,652,774, incorporated herein by reference in its entirety.

Examples of sulfonamide plasticizers include, but are not limited to, aromatic sulfonamides such as N-(2-hydroxypropyl)benzene sulfonamide (sold under the tradename UNIPLEX 225 by Unitex Chemical Co.), N-ethyl toluene sulfonamides, N-(n-butyl)benzene sulfonamide, N-cyclohexyl-p-toluenesulfonamide, and the like.

Other plasticizers suitable for use in the present invention include, for example, C₃-C₂₀ dialkyl esters of aliphatic dicarboxylic acids such as adipic acid, e.g., dioctyl adipate, dibutyl adipate, di(2-ethylhexyl)adipate, diisononyl adipate, diisodecyl adipate, and di(heptyl, nonyl)adipate as well as glycol esters of benzoic acid such as dipropylene glycol dibenzoate and dipropylene glycol monobenzoate.

The plasticizer can be present in the composition in an amount of from about 0 wt. % to about 20 wt. %, from about 0 wt. % to about 10 wt. % or from about 0 wt. % to about 5 wt. %.

### Filler

The composite composition may include a filler. Fillers may be included to impart particular properties to the composite include reinforcement, strength, color, conductivity, etc. The filler may be an organic or inorganic filler, Examples of suitable fillers include, but are not limited to, clays, nano-clays, organo-clays, ground calcium carbonate, precipitated calcium carbonate, colloidal calcium carbonate, calcium carbonate treated with compounds containing a stearate moiety or stearic acid, fumed silica, precipitated silica, crushed quartz, ground quartz, alumina, aluminum hydroxide, ceramic and glass spheres, titania, titanium hydroxide, zirconium oxide, zinc oxide, kaolin, bentonite montmorillonite, diatomaceous earth, iron oxide, PTFE powder, carbon black and graphite, talc, mica, pumice, wollastonite, dolomite, feldspar and combinations thereof. In one embodiment, the composition comprises a filler that includes fused silica.

The filler can be present in the composition in an amount of from about 30 wt. % to about 85 wt. %, from about 60 wt. % to about 85 wt. % or from about 75 wt. % to about 85 wt. %.

The compositions may be provided as one-part or two-part systems as may be desired for a particular purpose or intended application. The selection of the resin may contribute to whether the compositions is provided as a one or two-part system. In one embodiment, the composition is selected to provide an epoxy resin composition as may be useful to form an epoxy molding compound. The epoxy resin composition can be provided as a one-part or a two-part system. In one embodiment, the composition is a two-part composition comprising (i) a first part comprising an epoxy resin; and (ii) a second part comprising a resin hardener and a catalyst, where the imide functional polyorganosiloxane can be provided in the first and/or the second part. Additionally, other components such as fillers, plasiticizers, etc. can be provided in either the first or second part.

The composite composition may have a CTE of less than 12 ppm. In embodiments, the composite can have a CTE less than 12 ppm, less than 11 ppm, less than 10 ppm., less than 9 ppm., or less than 8 ppm. In embodiments, the composite composition has a CTE of from about 5 ppm to about 12 ppm, from about 7 ppm to about 11 ppm, or from about 8 to about 10 ppm. The CTE values as used for the above ranges refer to the CTE α1 value, which represents the coefficient of thermal expansion below the temperature of Tg. The CTE can be measured by (i) extruding a material to form a bar (80 mm×10 mm×t4 mm) by a molding machine at a molding temperature of 175° C. for 5 mins, (ii) placing the bar into an oven at a temperature of 175° C. for 5 hours, (iii) cutting the bar to a size of (10 mm×5 mm×t4 mm) for TMA, and (iv) Heating the sample piece from room temperature to 300° C. at a rate of 5° C./min, under a load being 0.1 N. The standard calculation temperatures range for CTE α1 is from 25° C. to 80° C.

In one embodiment, the material formed from the composition has a glass transition temperature (Tg) of from about 110° C. to about 140° C., from about 115° C. to about 135° C., or from about 120° C. to about 130° C.

In one embodiment, the composition has a spiral flow of at least about 50 cm, at least about 60 cm, or at least about 70 cm. In one embodiment, the composition has a spiral flow of from about 50 cm to about 100 cm, from about 60 cm to about 90 cm, or from about 70 cm to about 80 cm.

The composite material can be formed by mixing the composition with planetary mixer and kneader or rolling mill. Then the mixture is extruded and heated at 175° C. for 5 min. with transfer molding machine and cured composite material is obtained. The compositions of the invention are useful in a variety of applications in the manufacture of electronic devices, such as underfills, encapsulants and solder bump reinforcement. An electronic assembly may be formed by providing an electronic component and a substrate, wherein one of the electronic component and the substrate has a plurality of interconnect structures and the other has a plurality of conductive bonding pads; electrically connecting the electronic component and the substrate; forming an underfill composition between the electronic component and the substrate; and curing the underfill composition; wherein the underfill composition comprises a liquid cyclic siloxane comprising a plurality of glycidyl ether moieties; an aromatic thermosetting resin; and a curing agent. The present compositions may be cured by any suitable means, such as by heating at a suitable temperature to cause the compositions to cure.

In one embodiment, the compositions of the invention may be used as capillary underfill encapsulants in semiconductor packaging materials, such as to protect fragile electronic components, such as flip chip ball grid array (FC-BGA) and chip-scale packages (CSP).

The present technology has been described in the foregoing detailed description and with reference to various aspects and embodiments. The technology may be further understood with reference to the following Examples. The Examples are intended to further illustrate aspects and embodiments of the present technology and not necessarily to be limited to such aspects or embodiments.

### Examples

Composite materials are prepared using an epoxy resin and an imide functional organopolysiloxane. The composites are prepared as follows. 5.56 g of YX-4000H, 1.39 g of NC-3000, 5.82 g of MEHC-7800, 1.91 g of ETM90 (Momentive Performance Materials), 0.14 g of Silquest A-187, 0.09 g of Triphenylphosphine and 85.00 g of FB560 (Fused silica, Denka) are added into planetary mixer. The mixture is stirred at 25° C. for 10 min. Then the mixture is uniformly dispersed with rolling mill at 105° C. for 5 min. The mixture is extruded with transfer molding machine heating at 175° C. for 5 min. Properties such as CTE, modulus and flexural strength are measured with the cured composite material. The imide functional organopolysiloxanes used in the compositions were prepared as descried below.

Example 1; E2-1: Synthesis of organopolysiloxane with pendant groups, Structure A, with average chemical formula where w=44, x=1, y=5, & z=5. (1) A pendant hydride siloxane, MD₄₄D′₁₁M (150 g), 2-allylisoindoline-1,3-dione (7.4 g), and methylbenzene (150 mL) were charged into an appropriate size three necked round bottomed flask fitted with a thermopocket, a condenser, and a dropping funnel. The temperature of the reaction mixture was raised to 93° C. before adding 10 ppm of platinum catalyst to the reaction mixture. (2) After the completion of step 1, α-methyl styrene (25.69 g) was taken into the dropping funnel and was added dropwise to the reaction mixture. The internal temperature of the reaction mixture was raised to 96.5° C. after complete addition of α-methyl styrene and stabilization of the exotherm. (3) After the completion of step 2, allyl glycidyl ether (33.9 g) was taken into the dropping funnel and added dropwise to the reaction mixture. After the completion of the reaction, charcoal treatment of the mixture was performed to remove the colloidal Pt, while stirring the mixture for 4 hours at 50° C. The treated material was filtered and separated from the charcoal by using a sintered funnel with a celite bed, and the filtrate was collected. Then the solvent was removed from the filtrate to obtain the product as a yellow-coloured viscous product, Structure A.

Example 2, E2-2: Synthesis of organopolysiloxane with pendant groups, Structure A, with average chemical formula where w=11, x=0.5, y=1.8, & z=1.7. (1) A pendant hydride siloxane, MD₁₁D′₄M (150 g), 2-allylisoindoline-1,3-dione (8.52 g), and methylbenzene (50 mL) were charged into an appropriate size three necked round bottomed flask fitted with a thermopocket and condenser, and a dropping funnel. The temperature of the reaction mixture was raised to 90° C. before adding 10 ppm of platinum catalyst to the reaction mixture. (2) After the completion of step 1, α-methyl styrene (28.77 g) was taken in the dropping funnel and added dropwise to the reaction mixture. After complete addition of α-methyl styrene, the temperature of the reaction mixture was raised to 95° C. (3) After the completion of step 2, allyl glycidyl ether (37.91 g) was taken in the dropping funnel and added dropwise to the reaction mixture. After the completion of the reaction, charcoal treatment of the mixture was performed to remove the colloidal Pt, while stirring the mixture for 4 hours at 50° C. The treated material was filtered and separated from charcoal, by using a sintered funnel with a celite bed, and the filtrate was collected. The solvent was then removed from the filtrate to obtain a yellow-coloured viscous product, Structure A. Examples, E2-3 to E2-5 were prepared by similar experimental method.

Example 3, E1-X: Synthesis of organopolysiloxane, Structure B, N,N-diallyl pyromellitic diimide (20 g) was taken in a round bottom flask equipped with a thermometer, condenser, and dropping funnel. Methylbenzene was added to dissolve the diimide. Then, the temperature of the mixture was raised to 75° C., followed by addition of telechelic hydride siloxane, M′D1₂M′ (150 g) into the RBF. Then, 10 ppm of Platinum catalyst was added to the reaction mixture and an exotherm was observed during the addition of hydride. After the stirring the mixture for 2 hours, proton NMR was recorded. Upon consumption of the N,N-diallyl pyromellitic diimide, further endcapping of imide modified siloxane hydride was done with allyl glycidyl ether (25 g). The reaction mixture was allowed to stir for completion at 75° C. Then, proton NMR was recorded to check for complete consumption of hydride. After the completion of the reaction, the charcoal treatment of the mixture was done to remove the colloidal Pt, while stirring the mixture for 4 hours at 50° C. The treated material was filtered and separated from charcoal, by using sintered funnel with celite bed, and the filtrate was collected. The solvent was then removed from the filtrate to obtain a light yellow-coloured viscous material, Structure B.

TABLE 1
Examples of imide functionalized organopolysiloxane

| Imide | | Average | GPC characterization | | | Viscosity, | |
|---|---|---|---|---|---|---|---|
| functionalized | | D-units | Mₙ | M_{w} | | η | Refractive |
| organopolysiloxane | R-groups | (w, x, y, z) | (gmol⁻¹) | (gmol⁻¹) | PDI | (Pas) | index |
| E1-1 | R₁-R₁₂ = Me | w + x + y + z = | 3696 | 7892 | 2.1 | 0.19 | 1.422 |
| | | 25 | | | | | |
| E1-2 | R₁-R₁₂ = Me | w + x + y + z = | 3025 | 5798 | 1.9 | 0.30 | 1.436 |
| | | 12 | | | | | |
| E1-3 | R₁-R₁₂ = Me | w + x + y + z = | 12859 | 19579 | 1.5 | 2.38 | 1.443 |
| | | 13 | | | | | |
| E1-4 | R₁-R₁₂ = Me | w + x + y + z = | 24373 | 56676 | 2.3 | 209 | 1.443 |
| | | 13 | | | | | |
| E1-5 | R₁-R₁₂ = Me | w + x + y + z = | 3016 | 8802 | 2.9 | 1.13 | 1.441 |
| | | 9 | | | | | |
| E2-1 | R₁, R₂, R₃, R₄, R₅, R₇, R₉, R₁₁, | w = 11, | 3017 | 4823 | 1.6 | 0.04 | 1.443 |
| | R₁₂ = Me; | x = 0.5, | | | | | |
| | R₆ = imide; R₈ = epoxy, | y = 1.8, & | | | | | |
| | R₁₀ = phenyl | z = 1.7 | | | | | |
| E2-2 | R₁, R₂, R₃, R₄, R₅, R₇, R₉, R₁₁, | w = 44, | 5161 | 12714 | 2.5 | 0.23 | 1.445 |
| | R₁₂ = Me; R₆ = imide; R₈ = | x = 1, y = 5, | | | | | |
| | epoxy, R₁₀ = phenyl | & z = 5. | | | | | |
| E2-3 | R₁, R₂, R₃, R₄, R₅, R₇, R₉, R₁₀, | w = 15, | 2273 | 6715 | 2.9 | 0.66 | 1.460 |
| | R₁₁, R₁₂ = Me; R₆ = imide; | x = 3.3, | | | | | |
| | R₈ = epoxy | y = 1.7, & | | | | | |
| | | z = 0 | | | | | |
| E2-4 | R₁, R₂, R₃, R₄, R₅, R₇, R₉, R₁₀, | w = 15, | 1645 | 4116 | 2.5 | 0.25 | 1.456 |
| | R₁₁, R₁₂ = Me; R₆ = imide; | x = 2.5, | | | | | |
| | R₈ = epoxy | y = 2.5, & | | | | | |
| | | z = 0 | | | | | |
| E2-5 | R₁, R₂, R₃, R₄, R₅, R₇, R₉, R₁₀, | w = 15, | 1349 | 4092 | 3.0 | 0.12 | 1.441 |
| | R₁₁, R₁₂ = Me; R₆ = imide; | x = 1.25, | | | | | |
| | R₈ = epoxy | y = 3.75, & | | | | | |
| | | z = 0 | | | | | |

The composition of the embodiments comprised of epoxy resins in combination with bisphenol or bisphenol crystalline epoxy resins or mixtures thereof such as YX-4000 available from Japan Epoxy Resins with epoxy equivalent of 197 g/eq and melting point of 105° C. along with CER-3000 available from NIPPON KAYAKU CO., LTD with epoxy equivalence of 275 g/eq and melting point of 58° C. These have been used in combination. Along with functional resin based on epoxy, polyphenolic resin hardener MEHC-7800 available from Meiwa Kasei with hydroxyl equivalence of 175 g/eq and melting point ranging from 61-90° C. has been used. Furthermore, the composition contains a Momentive proprietary silane Silquest A-187, along with filler of fused silica (FB560, Denka, 17.5 μm, 3.8 m2/g), wax and either control additives (Siloxane 1/Siloxane 2 or Benchmark additive) or imide-functionalized organopolysiloxane.

The composite materials were prepared according to the formulations described in Table 2.

TABLE 2
Formulations used for various examples

| | | | | | | Composition, | Composition, |
|---|---|---|---|---|---|---|---|
| | | Control | | | | with | with |
| | | 1 | | | Control | additives | additives |
| | Component | (w/o | Control | Control | 4/ | E1-1 to | E2-1 to |
| Components | specification | additive) | 2 | 3 | Benchmark | E1-5 | E2-5 |
| Epoxy Resin | Bisphenol | 6.37 | 5.94 | 5.94 | 5.94 | 5.94 | 5.94 |
| | Epoxy | | | | | | |
| | Monomer | | | | | | |
| | (YX- | | | | | | |
| | 4000H) | | | | | | |
| | Biphenyl | 1.59 | 1.48 | 1.48 | 1.48 | 1.48 | 1.48 |
| | epoxy | | | | | | |
| | (NC3000) | | | | | | |
| Hardener | Phenol | 6.67 | 6.22 | 6.22 | 6.22 | 6.22 | 6.22 |
| | Aralkyl | | | | | | |
| | Resin | | | | | | |
| | (MEHC- | | | | | | |
| | 7800) | | | | | | |
| Siloxane | MPM | 0.00 | 1.02 | 0.00 | 0.00 | 0.00 | 0.00 |
| Additive 1 | proprietary | | | | | | |
| | material | | | | | | |
| | ETM90 | | | | | | |
| Siloxane | MPM | 0.00 | 0.00 | 1.02 | 0.00 | 0.00 | 0.00 |
| Additive 2 | proprietary | | | | | | |
| | material | | | | | | |
| | ElectroSil | | | | | | |
| | SIM768E | | | | | | |
| Benchmark | | 0.00 | 0.00 | 0.00 | 1.02 | 0.00 | 0.00 |
| Siloxane | | | | | | | |
| Additive | | | | | | | |
| Imide | E1-1 to | 0.00 | 0.00 | 0.00 | 0.00 | 1.02 | 0.00 |
| functionalized | E1-5 | | | | | | |
| organopolysiloxane; | | | | | | | |
| Imide | E2-1 to | 0.00 | 0.00 | 0.00 | 0.00 | 0.00 | 1.02 |
| functionalized | E2-5 | | | | | | |
| organopolysiloxane; | | | | | | | |
| Silane | Silquest A- | 0.16 | 0.15 | 0.15 | 0.14 | 0.15 | 0.15 |
| | 187 | | | | | | |
| Cure Promoter | | 0.10 | 0.10 | 0.10 | 0.09 | 0.10 | 0.10 |
| Filler | Fused Silica | 85.00 | 85.00 | 85.00 | 85.00 | 85.00 | 85.00 |
| Release Agent | Wax | 0.10 | 0.10 | 0.10 | 0.09 | 0.10 | 0.10 |
| Total | | 100 | 100 | 100 | 100 | 100 | 100 |

Various properties of the composites were evaluated including spiral flow, compression ratio, gelation time, glass transition temperature, coefficient of thermal expansion, and moisture absorption. The test methods for evaluating these properties are described below.

### Spiral Flow

In the spiral flow test the flow property of the epoxy molding compound was determined by measuring the length of the resin flowing along the path of a spiral cavity by using Transfer molding machine (MF-0 15, Technomarushichi Inc.). Sample for the spiral flow test was tableted sample of the powder sample of the epoxy molding compound. The spiral flow test was done according to the method EMI-1-66. Test conditions were set as follows: temperature 175° C., pressure 6.9 MPa, mold time 3 mins, Plunger speed 5 cm/s, and quantity of one shot ˜30 g.

### Compression Ratio (Molding Compression Ratio and Cure Shrinkage Ratio)

The sample from the extruder was made to be a bar (80 mm×10 mm×t4 mm) by a molding machine at a molding temperature of 175° C. for 5 mins, pressure 6.9 MPa, Plunger speed 5 cm/s, and quantity of one shot ˜32 g. Molding compression ratio was calculated by compare the size of mold with the size of the bar taken out from mold (before cure process) as:

$$molding compression rate ( \% ) = ( the size of mold - the size of the bar taken out from mold ) / the size of mold \times 100.$$

After measuring specimen of the bar taken out from mold, put the bar into an oven at a temperature of 175° C. for 5 hours and then leave at room temperature overnight. Cure shrinkage rate was calculated by compare the size bar taken out from mold (before cure process) with the size of the bar after curing process as:

$$molding compression rate ( \% ) = ( the size of bar taken out from mold which was before curing step - the size of the bar after curing process ) / the size of mold \times 100.$$

### Gelation Time

In the GELATION TIME test the gelation point of the epoxy molding compound was tested. In the test, a hot plate was heated to the temperature of 175° C. The powder sample of the epoxy molding compound was placed on the hot plate and let it stand as long as the sample was gelled, with stopwatch gelation time was measured (stopwatch was started immediately when the sample is placed on the hot plate and stopped when gelation was complete).

### GLASS TRANSITION TEMPERATURE Tg and E′ and E″ by DMA

Glass transition temperature of the epoxy molding compound can be determined by various method, such as Dynamic Mechanical Analyzer (DMA EXTEAR DMS6100, Hitachi high-tech science Inc.), and Thermo-mechanical Analyzer (TMA) and so on. Specifically, in the present application the sample from the extruder was made to be a bar (80 mm×10 mm×t4 mm) by a molding machine at a molding temperature of 175° C. for 5 mins. After molding, put the bar into an oven at a temperature of 175° C. for 5 hours. The cured bar was cut to be a size of (50 mm×3 mm×t4 mm) for DMA. Tg of the cut bar was measured using DMA, where the sample was placed in the DMA machine, the heating rate was 5° C./min, the heating was carried out until 300° C. under nitrogen flow by 300 mL/min, the frequency was 10 Hz, measurement mode was bending mode, and the Tg was obtained from the peak of tanδ.

### Coefficient of Thermal Expansion (CTE) by TMA

The CTE α1 and CTE α2 values were determined using a thermomechanical analyzer (TMA) TMA 8311 from Rigaku Inc, and test conditions were as follows:

In the present application the sample from the extruder was made to be a bar (80 mm×10 mm×t4 mm) by a molding machine at a molding temperature of 175° C. for 5 mins. After molding, put the bar into an oven at a temperature of 175° C. for 5 hours. The cured bar was cut to be a size of (10 mm×5 mm×t4 mm) for TMA. Heating the sample piece from room temperature to 300° C. at a rate of 5° C./min, and the load being 0.1 N. To be specific CTE α1 represents the coefficient of thermal expansion below the temperature of Tg, and CTE α2 represents the coefficient of thermal expansion above the temperature of Tg, and standard calculation temperatures range for CTE α1 is from 25° C. to 80° C., and calculation temperatures range for CTE α2 is from 150° C. to 250° C. From the testing FIGURES determing the CTE α1 and CTE α2 value, the value of Tg can be calculated as well by determining the crossing point of the data from CTE α1 and CTE α2.

### Moisture Absorption

Moisture absorption rate test method was carried out in accordance with the method of” PCT24” in which sample piece size was set as φ50*3 mm, and test condition is 121° C./100RH %/2atm/24 hrs. Moisture absorption rate can be calculated as: Weight increment of sample piece after PCT24 hrs/Weight of sample piece×100%.

The results from the testing are shown in Tables 3

TABLE 3

| | | | Control | | | Control | | | |
|---|---|---|---|---|---|---|---|---|---|
| | | | 1 (w/o | Control | Control | 4/ | | | |
| Properties | | Unit | additive) | 2 | 3 | Benchmark | E1-1 | E1-2 | E1-3 |
| Spiral Flow | | (cm) | 73 | 68 | 68 | 72 | 84 | 77 | 85 |
| Gel Time | | (s) | 30.3 | 29.8 | 24.9 | 28.6 | 28.1 | 28.1 | 29.4 |
| Water Absorption rate | | (%) | 0.32 | 0.30 | 0.38 | 0.35 | 0.32 | 0.31 | 0.32 |
| Molding | LHD* | (%) | 0.14 | 0.15 | 0.14 | 0.17 | 0.13 | 0.14 | 0.10 |
| compression ratio | SHD* | (%) | 0.00 | 0.00 | 0.00 | 0.07 | 0.00 | 0.03 | 0.00 |
| Cure shrinkage | LHD* | (%) | 0.19 | 0.19 | 0.23 | 0.21 | 0.18 | 0.18 | 0.23 |
| ratio | SHD* | (%) | 0.20 | 0.13 | 0.27 | 0.20 | 0.26 | 0.17 | 0.18 |

| DMA | | | | | | | | |
|---|---|---|---|---|---|---|---|---|
| E′ @ 25° C. | (MPa) | 18.3 | 18.9 | 17.0 | 11.9 | 14.1 | 14.1 | 14.0 |
| E′ @ 50° C. | (MPa) | 17.9 | 18.5 | 16.5 | 11.2 | 13.8 | 13.8 | 13.6 |
| E′ (shoulder) | (° C.) | 120 | 117.1 | 110.1 | 106.1 | 126.7 | 126.3 | 125.9 |
| E″ (peak) | (° C.) | 126.3 | 123.7 | 119.2 | 115.2 | 131.2 | 131.4 | 130.6 |
| tan δ (peak) = T_{g} by DMA | (° C.) | 133.1 | 130.2 | 127.6 | 124.6 | 136.7 | 138.0 | 136.1 |
| | | | 165.4 | | | | | |
| TMA | | | | | | | | |
| T_{g} | (° C.) | 117.4 | 118.1 | 100.6~116.3 | 103.3 | 127.7 | ~119.7 | 128.2 |
| CTE α1 (25-80° C.) | (ppm) | 11.0 | 10.0 | 11.0 | 10.0 | 10.2 | 10.5 | 9.8 |
| CTE α2 (150-250° C.) | (ppm) | 44.0 | 37.0 | 50.0 | 45.0 | 46.4 | 44.7 | 44.3 |
| CTE (25-250° C.) | (ppm) | 30.5 | 24.6 | 37.5 | | 30.5 | 28.6 | 30.4 |

| Properties | | Unit | E1-4 | E1-5 | E2-1 | E2-2 | E2-3 | E2-4 | E2-5 |
|---|---|---|---|---|---|---|---|---|---|
| Spiral Flow | | (cm) | 69 | 71 | 78 | 59 | 81 | 79 | 77 |
| Gel Time | | (s) | 31.9 | 28.7 | 32.1 | 25.6 | 24.9 | 27.7 | 27.7 |
| Water Absorption rate | | (%) | 0.32 | 0.32 | 0.31 | 0.31 | 0.34 | 0.31 | 0.32 |
| Molding | LHD* | (%) | 0.12 | 0.12 | 0.15 | 0.14 | 0.11 | 0.13 | 0.12 |
| compression ratio | SHD* | (%) | 0.03 | 0.03 | 0.07 | 0.03 | 0.00 | 0.00 | 0.00 |
| Cure shrinkage | LHD* | (%) | 0.18 | 0.17 | 0.17 | 0.18 | 0.13 | 0.18 | 0.16 |
| ratio | SHD* | (%) | 0.10 | 0.26 | 0.13 | 0.13 | 0.03 | 0.23 | 0.23 |

| | | | | | | | | |
|---|---|---|---|---|---|---|---|---|
| DMA | | | | | | | | |
| E′ @ 25° C. | (MPa) | 14.1 | 14.0 | 14.0 | 13.3 | 14.5 | 14.4 | 14.1 |
| E′ @ 50° C. | (MPa) | 13.8 | 14.0 | 13.7 | 13.1 | 14.3 | 14.0 | 13.7 |
| E′ (shoulder) | (° C.) | 119.2 | 125.1 | 120.6 | 126.8 | 116.5 | 122.2 | 123.1 |
| E″ (peak) | (° C.) | 123.9 | 129.2 | 125.7 | 132.0 | 121.3 | 128.8 | 127.2 |
| tan δ (peak) = T_{g} by DMA | (° C.) | 129.7 | 134.9 | 131.7 | 137.2 | 127.8 | 132.9 | 133.2 |
| TMA | | | | | | | | |
| T_{g} | (° C.) | 132.2 | 128.2 | 119.0 | 116.4 | 116.8 | 116.4 | 116.1 |
| CTE α1 (25-80° C.) | (ppm) | 10.0 | 9.7 | 8.4 | 8.9 | 9.5 | 10.3 | 10.5 |
| CTE α2 (150-250° C.) | (ppm) | 42.0 | 41.7 | 41.6 | 42.6 | 43.5 | 43.5 | 43.7 |
| CTE (25-250° C.) | (ppm) | 27.2 | 26.4 | 26.2 | 27.9 | 29.6 | 29.4 | 29.7 |

*LHD: Long hand direction; SHD: Short hand direction
DMA: Dynamic Mechanical Analysis
TMA: Thermomechanical Analyzer
E′: storage modulus
E″: Loss modulus
T_{g}: Glass transition temperature
CTE: coefficient of thermal expansion

The results in Table 3 for the prepared compositions, show clear lowering in the property of CTE α1 (25 to 80° C.) over the control samples as well as the benchmark, for the imide functionalized organopolysiloxane, with lowest value being 8.4 ppm. Furthermore, lowering in CTE α2 (150-250° C.) was also observed for imide functionalized organopolysiloxane compositions compared to the control samples. Wherever the CTE value of the compositions having imide functionalized organopolysiloxanes (for examples, E1-2, E2-4, E2-5) were found to be comparable with control or benchmark-based compositions, it was compensated with improved properties of spiral flow or reduced water absorption rate or lowered cure shrinkage ratio as shown in Table 3. Furthermore, the mechanical properties were found to be improved for compositions with imide functionalized organopolysiloxane when compared with benchmark composition.

What has been described above includes examples of the present specification. It is, of course, not possible to describe every conceivable combination of components or methodologies for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

The foregoing description identifies various, non-limiting embodiments of a composite resin composition. Modifications may occur to those skilled in the art and to those who may make and use the invention. The disclosed embodiments are merely for illustrative purposes and not intended to limit the scope of the invention or the subject matter set forth in the claims.

What is claimed is:

1. A composition comprising:
an imide-functionalized organopolysiloxane comprising an imide functional group, and at least one functional group selected from an epoxy, a hydride, an aromatic, an aliphatic, an amine, and/or an acryl or acryloxy, where the organopolysiloxane is selected from a linear siloxane and a non-linear siloxane, wherein the non-linear siloxane comprises at least two of said functional groups selected from an epoxy, a hydride, an aromatic, an aliphatic, an amine, and/or an acryl or acryloxy;
a polymer resin that is reactive with the imide-functionalized organopolysiloxane;
a catalyst;
a filler; and
optionally an adhesion promoter, a release agent, and a plasticizer,
wherein the composition provides a coefficient of thermal expansion (CTE) value less than 12 ppm.

2. The composition of claim 1, wherein the imide-functionalized organopolysiloxane is according to formula (I) 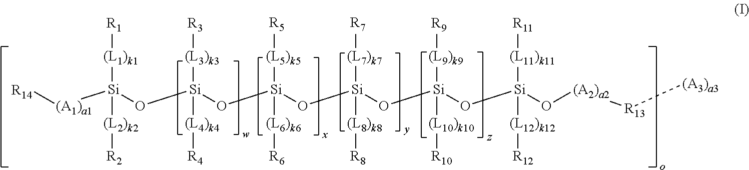
where R₁, R₂, R₃, R₄, R₅, R₆, R₇, R₈, R₉, R₁₀, R₁₁, R₁₂, R₁₃, and R₁₄ are each independently selected from hydrogen, a C1-C15 alkyl, an epoxy group, a C6-C30 aromatic containing group, and a imide group, with the provisos that (i) at least one of R¹, R², R³, R⁴, R⁵, R⁶, R⁷, R⁸, R⁹, R¹, R¹¹, R¹², R¹³, and R¹⁴ is selected from an imide group, and (ii) at least one of R¹, R², R³, R⁴, R⁵, R⁶, R¹, R⁸, R⁹, R¹⁰, R¹¹, R¹², R¹³, and R¹⁴ is selected from an epoxy group;
A₁, A₂, A₃, and L₁, L₂, L₃, L₄, L₅, L₆, L₇, L₈, L₉, L₁₀, L₁₁, and L₁₂ are linker groups each independently selected from a divalent alkyl group, a divalent alkenyl group, and a divalent ether groups;
o is ≥1;
w, x, y, and z are each ≥0, where (w+x+y+z) is from 1 to 60;
k1, k2, k3, k4, k5, k6, k7, k8, k9, k10

3. The composition of claim 2, wherein at least one of R₁, R₂, R₃, R₄, R₅, R₆, R₇, R₈, R₉, R₁₀, R₁₁, and/or R₁₂ is selected from an imide, at least one of R₁, R₂, R₃, R₄, R₅, R₆, R₇, R₈, R₉, R₁₀, R₁₁, and/or R₁₂ is selected from an epoxy, and least one of R₁, R₂, R₃, R₄, R₅, R₆, R₇, R₈, R₉, R₁₀, R₁₁, and/or R₁₂ is selected from an C6-C30 aromatic group.

4. The composition of claim 2, wherein R₁, R₂, R₃, R₄, R₅, R₇, R₉, R₁₀, R₁₁, and R₁₂ are independently selected from hydrogen, a C1-C15 alkyl group, and a C6-C30 aromatic, R₁₃ is selected from an imide functional group, and R₁₄ is selected from an epoxy functional group.

5. The composition of claim 2, wherein R₁, R₂, R₃, R₄, R₅, R₆, R₇, R₈, R₉, R₁₀, R₁₁, and/or R₁₂ are each independently selected from hydrogen and a C1-C15 alkyl group, and R₁₃ and R₁₄ are selected from a substituted or non-substituted bisimide.

6. The composition of claim 2, wherein the imide group is selected from a group of the formulas (IV), (V), and (VI): 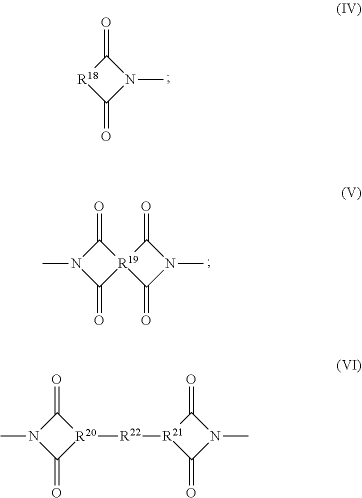
where R¹⁸, R¹⁹, R²⁰, and R²¹ are independently selected from a C2 to C30 divalent hydrocarbon, and R²² is selected from a bond or C1-C10 divalent hydrocarbon.

7. The composition of claim 1, wherein the imide-functionalized organopolysiloxane siloxane is of the formula:

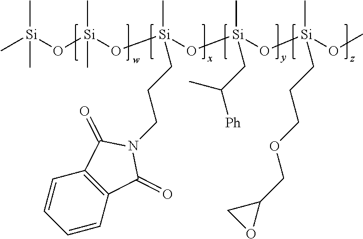

8. The composition of claim 1, wherein the imide-functionalized organopolysiloxane siloxane is of the formula:

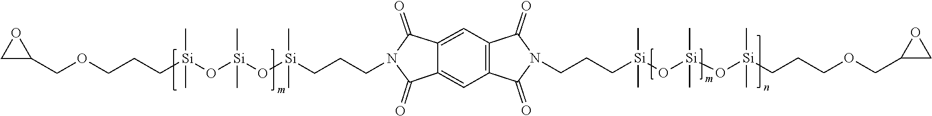

9. The composition of claim 1, wherein the imide-functionalized organopolysiloxane is present in an amount of from about 1 wt. % to about 10 wt.

10. The composition of claim 1, wherein the polymer resin is a combination of a functional resin and at least one resin hardener.

11. The composition of claim 1, wherein the functional resin is selected from an epoxy resin, a polyurethane resin, a polyamide resin, a polyimide resin, an acrylic resin, a siloxane resin, a phenol resin, or a combination of two or more thereof.

12. The composition of claim 11, wherein the functional resin is present in an amount of from about 7 wt. % to about 35 wt. %.

13. The composition of claim 1, wherein the resin hardener is selected from a phenol resin, a phenol-derived resin, a substituted phenol-derived resin, or an anhydrite resin.

14. The composition of claim 13, wherein the resin hardener is present in an amount of from about 5 wt. % to about 30 wt. %.

15. The composition of claim 1, wherein the composition comprises the resin hardener and the functional resin in a ratio of between 1:1 to 1:1.5.

16. The composition of claim 1, wherein the composition is a 2-part epoxy curing system.

17. The composition of claim 1, wherein the filler comprises alumina, fused silica, or combinations thereof.

18. The composition of claim 1, wherein the composition has a CTE value lower than 11 ppm.

19. The composition of claim 1 having a spiral flow of from about 50 cm to about 100 cm.

20. An epoxy molding compound formed from the composition of claim 1.

21. An article comprising a material formed from the composition of claim 1.

22. The article of claim 21 selected from a semiconductor packaging, an electronic material, or an electronic coating.

23. The article of claim 22 wherein the article is an electronic component comprising the material.
